(19) United States
(12) Patent Application Publication
(10) Pub. No.: US 2011/0032167 A1
(43) Pub. Date: Feb. 10, 2011

(54) UWB ANTENNAS

(76) Inventors: Gregory F. Dallum, Livermore, CA (US); Carlos E. Romero, Livermore, CA (US); Mark L. Vigars, Livermore, CA (US); Garth C. Pratt, Discovery Bay, CA (US); Peter C. Haugen, Livermore, CA (US)

Correspondence Address: LLNS / John P. Wooldridge;John H. Lee, Assistant Laboratory Counsel, L-703, P.O Box 808, Livermore, CA, 94551, US

(21) Appl. No.: 12/643,112

(22) Filed: Dec. 21, 2009

Related U.S. Application Data
(60) Provisional application No. 61/139,311, filed on Dec. 19, 2008.

(51) Int. Cl. H01Q 13/02; H01Q 9/16; H01Q 9/26

(52) U.S. Cl. 343/786; 343/793; 343/803

(57) ABSTRACT

Ultra-wideband (UWB) antennas for use with UWB transmitters and UWB receivers, that are useful, e.g., for UWB communications.

### RELATED APPLICATIONS

This application claims priority from Provisional Application Ser. No. 61/139,311 filed Dec. 19, 2008, which is herein incorporated by reference.

### GOVERNMENT RIGHTS

The United States Government has rights in this invention pursuant to Contract No. DE-AC52-07NA27344 between the United States Department of Energy and Lawrence Livermore National Security, LLC.

### BACKGROUND OF THE INVENTION

1. Field of the Invention

This invention pertains generally to ultra-wideband communications, and more particularly to ultra-wideband (UWB) antennas.

2. Description of Related Art

Ultra-wideband (UWB) wireless communication is based on the transmission of data in extremely short (50-1000 ps) pulses spread out over a broad range or bandwidth (typically several GHz) of the electromagnetic spectrum. Large data bursts, e.g. hundreds of Gb/s, are possible because the data are carried simultaneously at a wide range of frequencies across the electromagnetic spectrum.

UWB communications offers many advantages. UWB signals are more difficult to detect than narrowband (essentially single frequency) signals. The combination of broad spectrum, low power, and extremely short pulses also cause much less interference with other devices than do conventional narrowband wireless systems. Also, UWB is much more resistant to electrical interference from other devices than other wireless technology. Thus, UWB's data capacity, speed, low power requirements, and resistance to interference make it attractive as a communications technology.

UWB pulses spread the transmitted energy over many frequencies, over a band of typically several GHz, as opposed to traditional narrowband, which generally operates as a continuous wave at a specific frequency and covers a limited band of about 30 KHz. Cellular phones operate in the wideband, which covers about 5 MHz. UWB bandwidth provides high capacity, resistance to jamming, and low probability of detection. Thus UWB provides an attractive alternative to the other communications technologies. At present, the FCC restricts commercial UWB systems, but Government use is less restricted. UWB appears very promising for the future.

One type of receiver used in UWB communications systems is a delay and multiply receiver in which a received pulse is multiplied by a delayed prior received pulse to increase the magnitude. This requires a precise spacing between the transmitted pulses so that the delay can be chosen so that the presently received pulses are coincident with the delayed previously received pulses. It is also required that the pulses be in phase so that when they are multiplied they do not cancel out. At a minimum, a pair of pulses is required.

Thus, it is desirable to provide UWB antennas which can be used with UWB transmitters and receivers.

### BRIEF SUMMARY OF THE INVENTION

The present invention includes a series of unique UWB antenna embodiments which can be generally categorized into the classifications of horn antennas, disk cone antennas and dipole antennas. However, the unique geometrics, material selection, and configuration of the present embodiments permit them to perform in unique regimes.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 shows an exemplary Mombo antenna of the present invention.

FIG. 2 shows an exemplary M Monroe antenna of the present invention.

FIG. 3 shows an exemplary Cast antenna of the present invention.

FIG. 4 shows an exemplary HERMES antenna of the present invention.

FIG. 5 shows an exemplary Comm Antenna of the present invention.

FIG. 6 shows an exemplary Disk antenna of the present invention.

FIG. 7 shows an exemplary Imperial Shuttle antenna of the present invention.

FIG. 8 shows an exemplary Hex Antenna of the present invention.

FIG. 9 shows an exemplary Folded antenna of the present invention.

FIG. 10 shows an exemplary Paulson antenna of the present invention.

FIG. 11 shows an exemplary Mini antenna of the present invention.

FIG. 12 shows an exemplary Stex antenna leaf and tongue of the present invention.

FIG. 13 shows an exemplary Stex antenna frame assembly of the present invention.

FIG. 14 shows an exemplary Stex antenna frame of the present invention.

FIG. 15 shows an exemplary antenna housing of the present invention.

FIG. 16 shows an exemplary embodiment of the present invention.

### DETAILED DESCRIPTION OF THE INVENTION

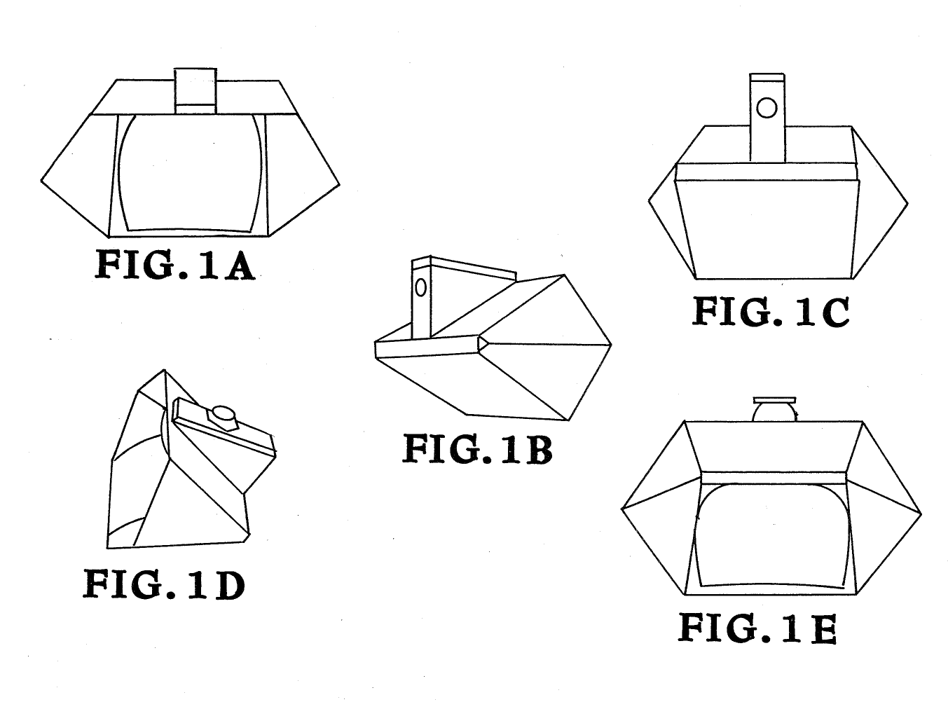

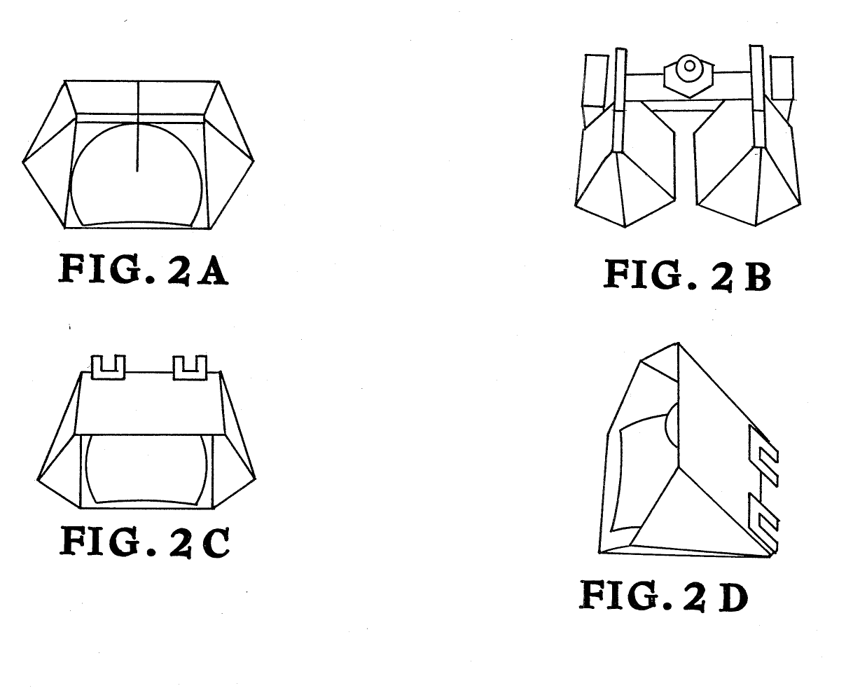

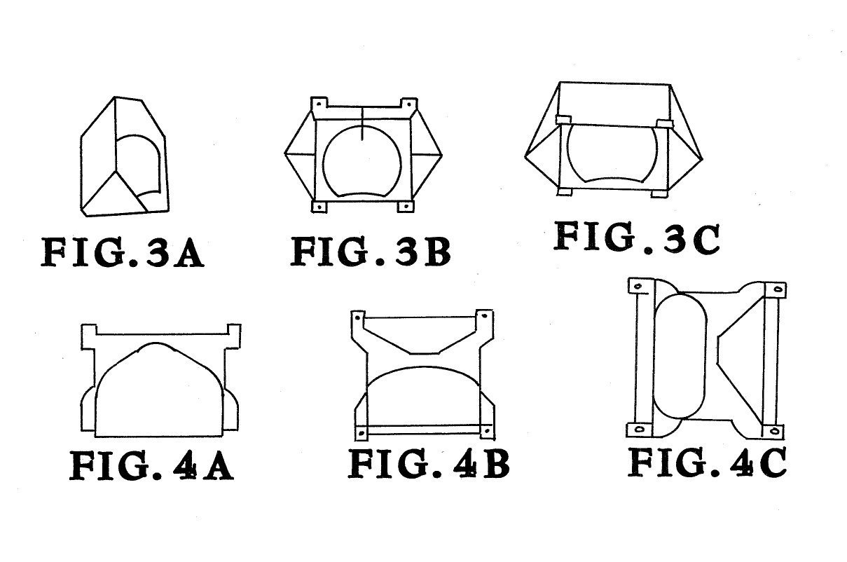

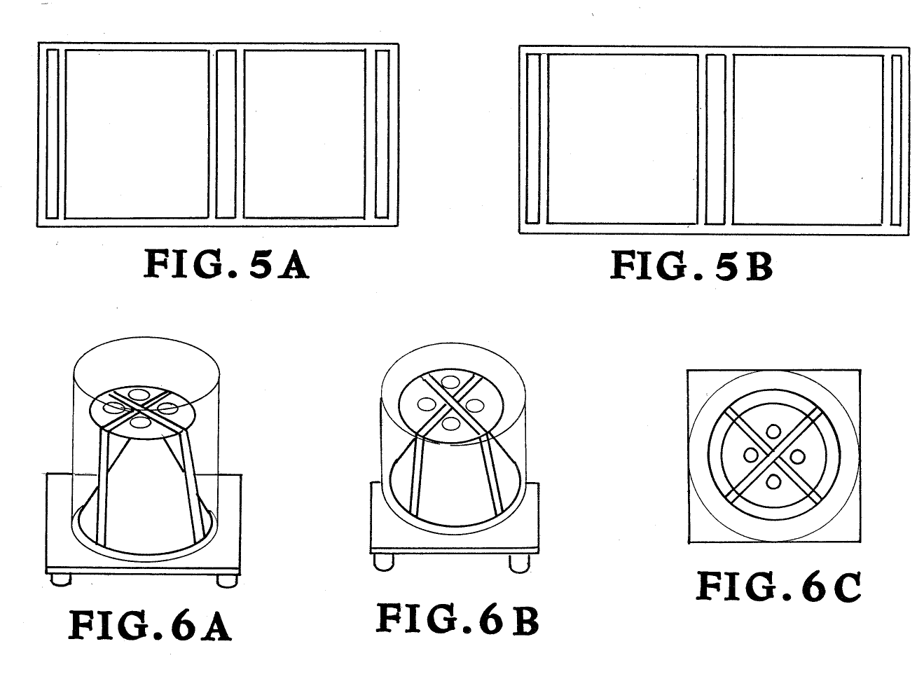

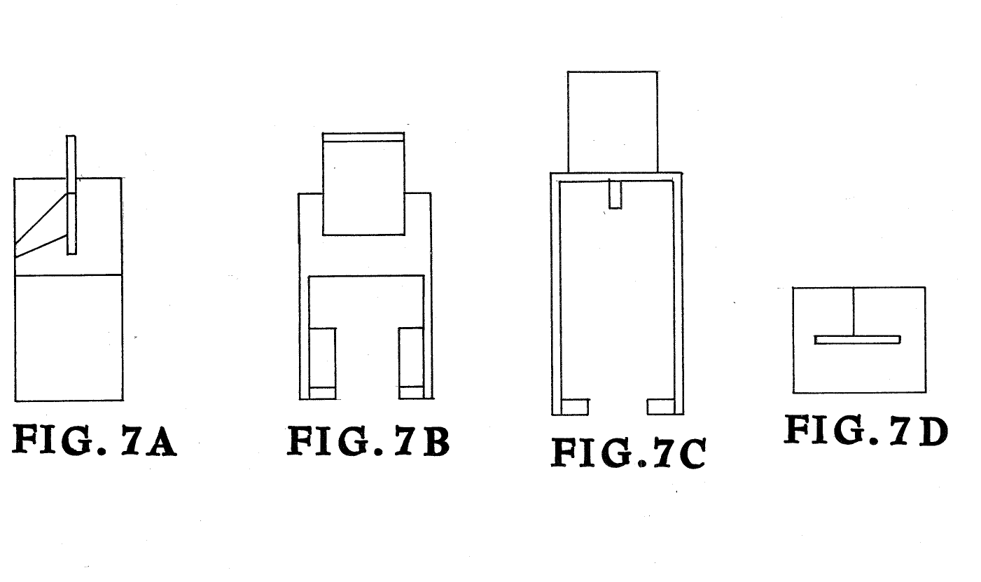

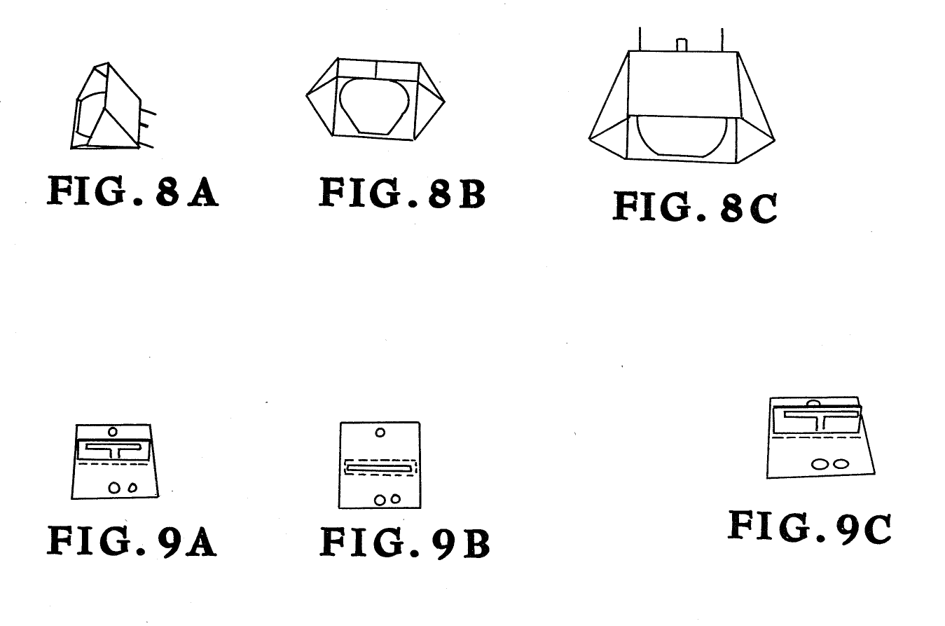

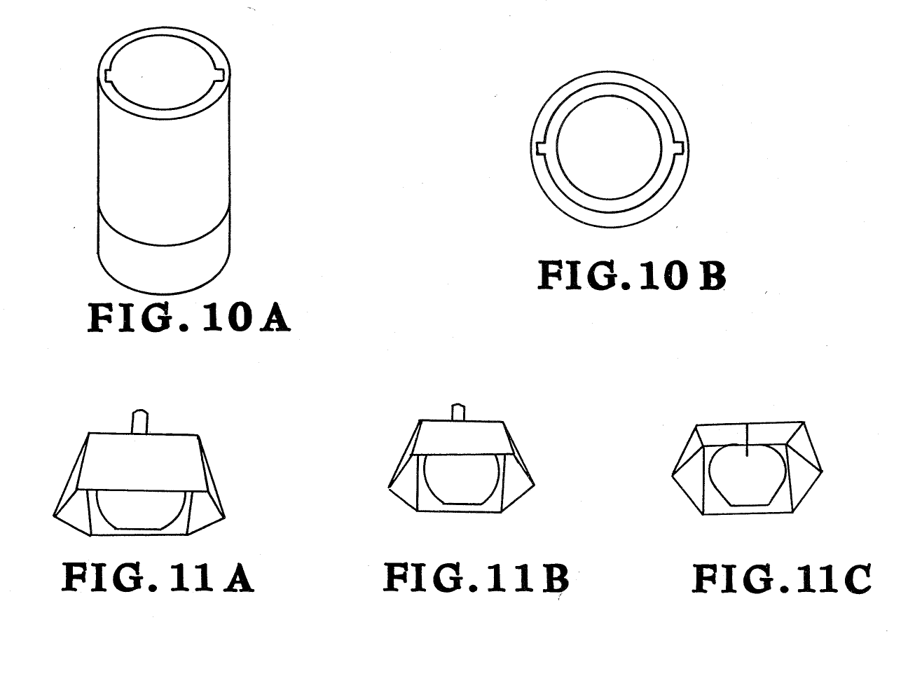

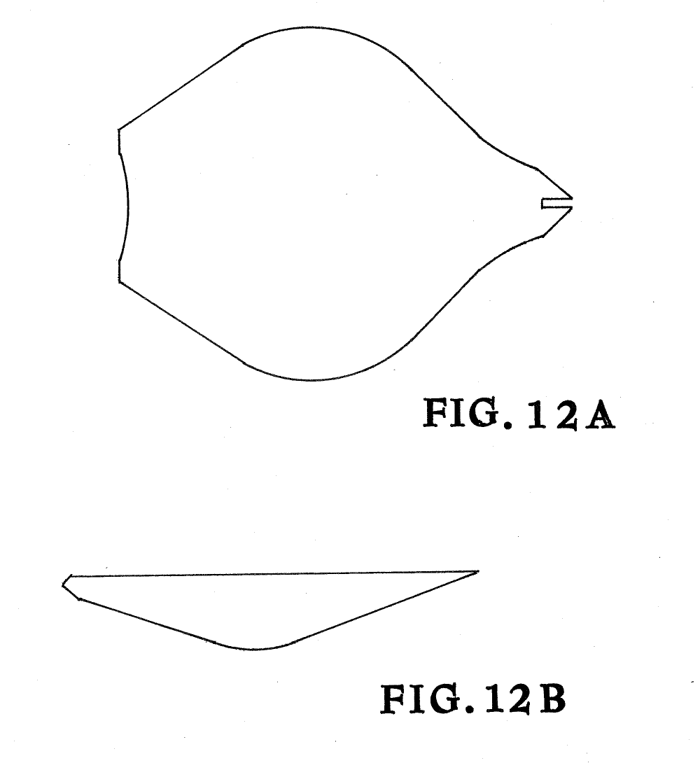

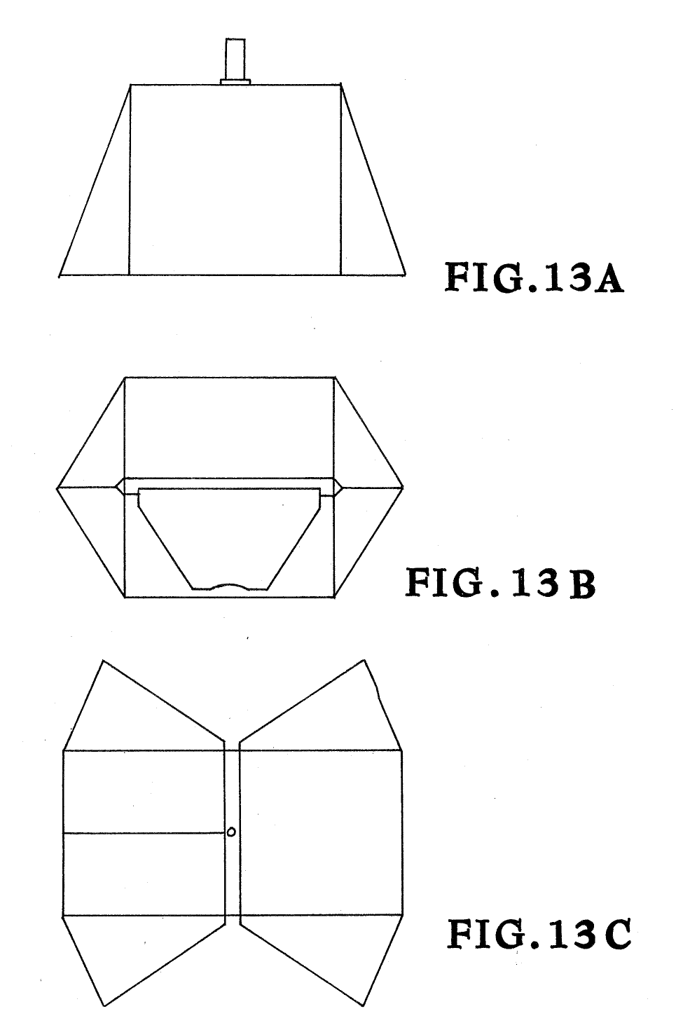

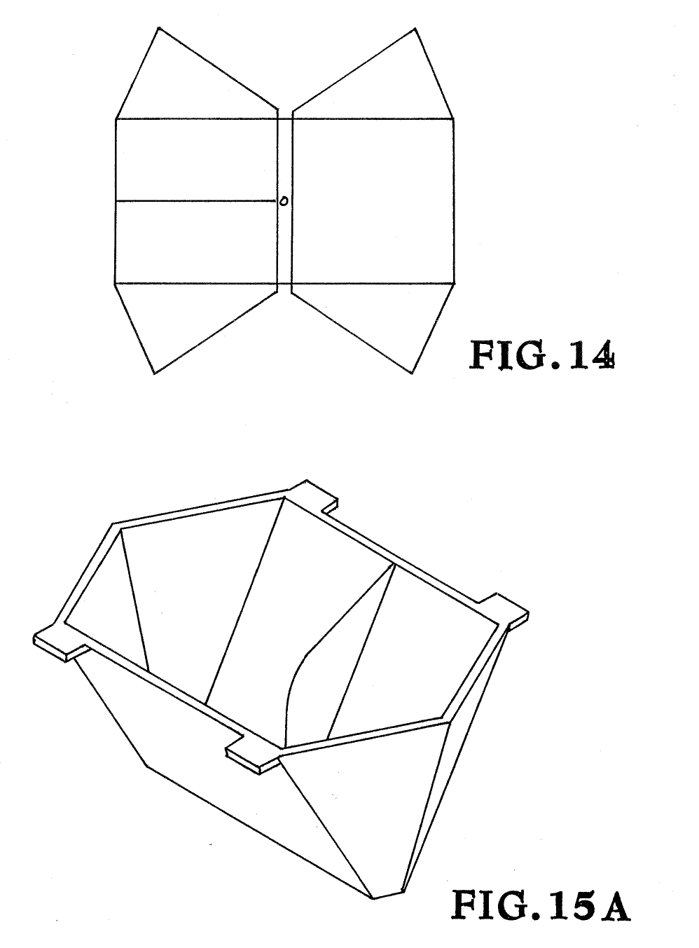

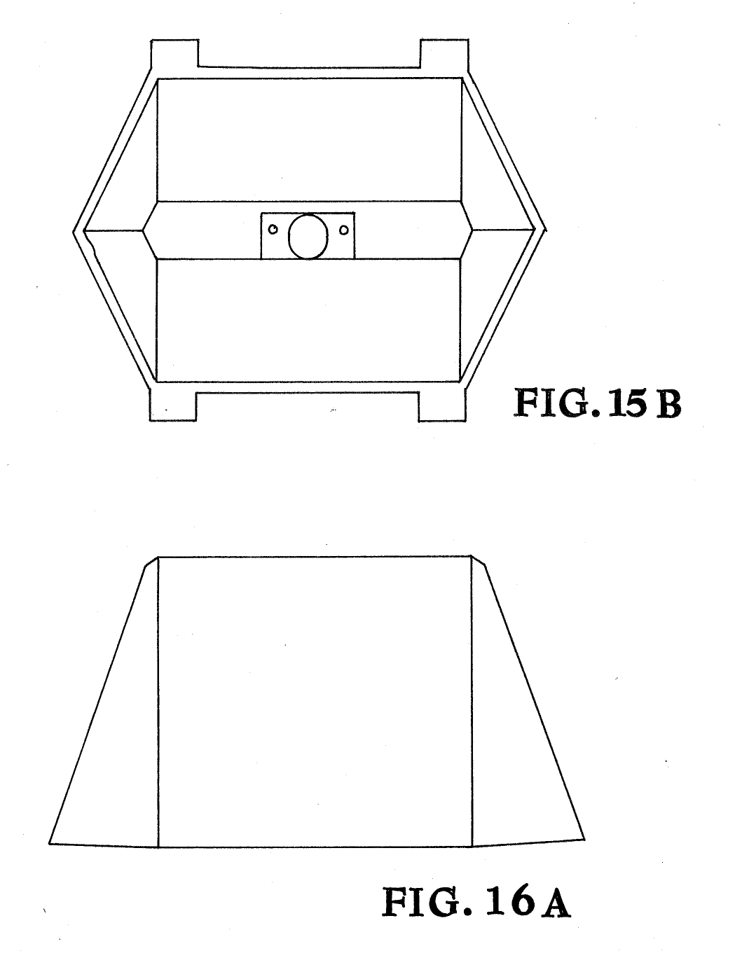

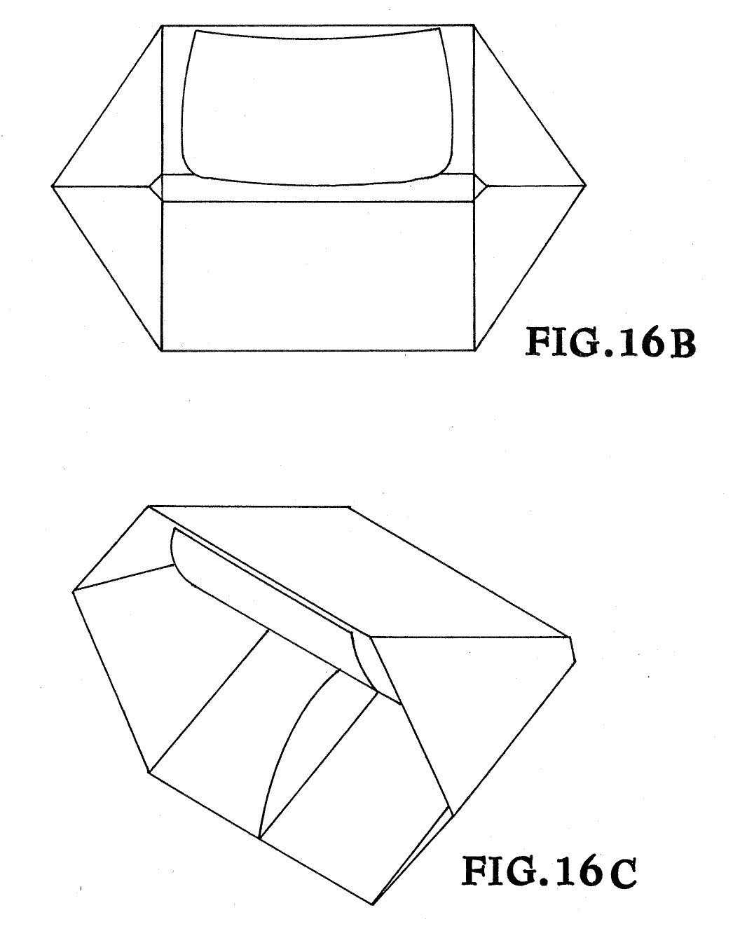

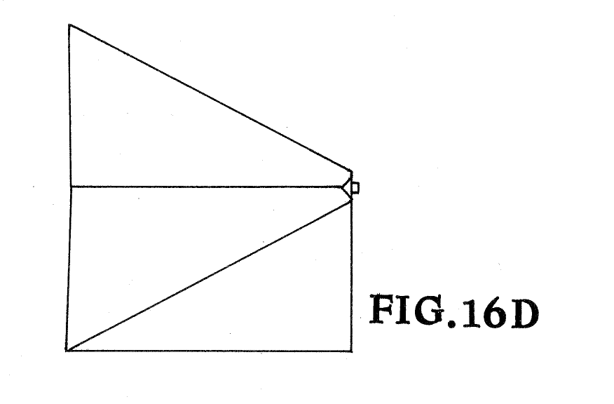

Referring more specifically to the drawings, for illustrative purposes the present invention is embodied in the apparatus generally shown in FIG. 1 through FIG. 16. It will be appreciated that the apparatus may vary as to configuration and as to details of the parts, without departing from the basic concepts as disclosed herein.

The invention provides exemplary ultra-wideband (UWB) antennas for use with UWB transmitters and UWB receivers, that are useful, e.g., for UWB communications.

The present invention includes a series of unique UWB antenna embodiments which can be generally categorized into the classifications of horn antennas, disk cone antennas and dipole antennas. However, the unique geometrics, material selection, and configuration of the present embodiments permit them to perform in unique regimes. Embodiments of the present invention are useful in upgrades to existing and new UWB radar, communications, and related systems for improved capabilities (e.g., intrusion sensing, UWB dipsticks, radar imaging velocity tracking).

The design of an UWB antenna is very complicated. An UWB antenna must propagate waves covering a wide range of frequencies and in some cases the range of frequencies can be several GHz of bandwidth. Phase delay associated with launching different frequencies at different points in the antenna is a large problem. Additionally, not having matching impedance along the entire range of frequencies launched can create reflections, cancellations and/or saturation. Without a proper design taking material into consideration as well as geometry, the size of the antennas can become quite large and the weight quite heavy. Although there are many designs out in industry, they work with varying success. One such Vivaldi design produces an antenna whose body occupies a cubic yard volume. In contrast, present designs performs comparably, but occupies a cubic foot. This example represents a reduction in volume by 27 times.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. An ultra-wideband antenna selected from the group consisting of a horn antenna, disk cone antennas and dipole antennas.

2. The antenna of claim 1, wherein said antenna comprises a Mombo antenna.

3. The antenna of claim 1, wherein said antenna comprises an M Monroe antenna.

4. The antenna of claim 1, wherein said antenna comprises a Cast antenna.

5. The antenna of claim 1, wherein said antenna comprises a HERMES antenna.

6. The antenna of claim 1, wherein said antenna comprises a Comm Antenna.

7. The antenna of claim 1, wherein said antenna comprises a Disk antenna.

8. The antenna of claim 1, wherein said antenna comprises an Imperial Shuttle antenna.

9. The antenna of claim 1, wherein said antenna comprises a Hex Antenna.

10. The antenna of claim 1, wherein said antenna comprises a Folded antenna.

11. The antenna of claim 1, wherein said antenna comprises a Paulson antenna.

12. The antenna of claim 1, wherein said antenna comprises a Mini antenna.

13. The antenna of claim 1, wherein said antenna comprises a Stex antenna.
